(19) United States
(12) Patent Application Publication
(10) Pub. No.: US 2002/0121171 A1
(43) Pub. Date: Sep. 5, 2002

(54) Bandsaw with double-edged blade and opposing thrust rollers

(76) Inventor: William Harold Falberg, Carbondale, CO (US)

Correspondence Address: DORR CARSON SLOAN & BIRNEY, PC, 3010 EAST 6TH AVENUE, DENVER, CO, 80206, US

(21) Appl. No.: 10/080,248

(22) Filed: Feb. 19, 2002

Related U.S. Application Data
(60) Provisional application No. 60/275,195, filed on Feb. 23, 2001.

(51) Int. Cl. B27B 13/00; B23D 53/00

(52) U.S. Cl. 83/820; 83/788; 83/835

(57) ABSTRACT

The blade guides of this invention depart from prior art by using the blade to drive thrust rollers, of resilient elastomeric construction, into which the blade's teeth are locked synergetically in an inverse manifestation of the chain and sprocket principle. Lateral thrust force against the blade's teeth is distributed equally along the blade's irregular edge by the correspondingly irregular shape of the elastomeric thrust roller creating an interface of sufficient area to thwart the cutting action of the blade's teeth.

Bandsaws of this invention can cut into a workpiece along a given line, stop, and either retrace that cut with ease, or cut backwards along an entirely different vector.

### RELATED APPLICATION

The present application is based in part on the Applicant's U.S. Provisional Patent Application No. 60/275195 entitled “An Improved Bandsaw” filed on Feb. 20, 2001.

### BACKGROUND OF THE INVENTION

1. Field of the Invention

The present invention relates generally to the field of bandsaw blades and the means by which they are guided through a workpiece. More specifically, the present invention discloses a thrust roller and blade combination capable of converting prior art bandsaws into double-edged bi-directional cutting systems.

2. Statement of the Problem

Bandsaw cuts involving sharp corners or acute angles require the operator to back the blade out of its cut and recut into that corner from another vector. This process is time consuming and difficult because the original cut leaves a rough surface inside the workpiece and the blade's trailing edge usually snags on something. The blade cannot be forced backwards because pushing on the trailing edge of a prior art bandsaw blade pulls that blade out of its prior art guides, which resist thrust from only one direction; i.e. the direction of the cut. Without this rearward thrust support the blade is pulled out of the blade guide and subsequently off the blade transport wheels.

Therefore, a need exists for a bandsaw blade guide with a thrust support bearing in front of, as well as behind, the blade.

The thrust support bearings of prior art, being made of hardened steel, can't be used for this purpose because: 1, the support bearing would be destroyed by the blade's cutting edge repeatedly beating on it; and 2, the blade's sharp cutting edges would be dulled by the hard, blunt steel of the bearing.

3. Prior Art

While prior art references to elastomer coated wheels, pulleys, and sheaves are numerous, the only one that claims an elastomeric thrust bearing is found in Miranti's U.S. Pat. No. 4,189,986 filed Feb. 26, 1980 in which he specifies a circumferential V-shaped groove designed to work with a knife-edged Mobius strip blade with two cutting edges. The bandsaw disclosed by Miranti are limited to single directional cuts with a knife-edged blade, therefore limiting its use to the cutting of paper.

4. Solution to the Problem

The present invention provides a bandsaw blade with teeth on both edges and a means to guide the blade forward or rearward with equal ease.

Experimentation has shown that the teeth of a bandsaw blade will cut into a freely idling elastomeric roller only to the point at which the gullets of the blade contact the outer surface of the roller if the teeth are consistently uniform in size and shape. Uneven teeth or a weld that breaks the uniformity of spacing would break the pattern of interlocking teeth and indentations of the thrust roller and result in rapid deterioration of the elastomer.

Since the essence of this invention is the syncronicity of blade and roller, four conditions must be met: 1, the teeth of the blade must be consistently uniform of size and shape and 2, the elastomeric roller must offer minimal resistance to rotation; 3, the elastomeric portion of the roller must be thicker than the depth of the blade's gullet in relation to the tips of its teeth; and 4, the blade must be supported parallel to the cut plain by pinch rollers that won't dull the blade's edges at the points of its set or set-off.

The time saving advantages of a double-edged bandsaw are obvious to those who would work with them. Some of the not-so-obvious advantages are: 1, elastomeric rollers are quieter, run cooler, and prolong blade life; 2, double-edged blades have a much tighter turning radius than single-edged blades; 3, double-edged blades track better on the rubber tires commonly used on blade transport wheels of prior art; and 4, having teeth on the trailing edge of a cutting blade tends to clean the kerf, thereby reducing drag on the motor.

### SUMMARY OF THE INVENTION

The bi-directional cutting system of this invention offers bandsaw operators a faster, easier way to cut architectural details and irregular shapes in a variety of materials. The bandsaws of this invention run quieter, cooler, and faster than prior art and they promote longer blade life. Furthermore, this system can be adapted to any existing bandsaw by simply and economically changing over to the blades and guides of this invention.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a top cross-sectional view of the preferred embodiment blade guide assembly.

FIG. 2 is a front plan view of the blade guide corresponding to FIG. 1.

FIG. 3 is a right side plan view of the blade guide corresponding to FIG. 1.

FIG. 4 is a fold-out view of the blade guide bracket of FIG. 1

FIG. 5 is a front plan view of the thrust rollers showing pattern of circumferential indentations that form inverse sprocket.

FIG. 6 is a side cross-sectional detail of the thrust rollers and their relationship to the blade.

FIG. 7 is a side cross-sectional view of a possible embodiment of this invention being used to augment a prior art blade guide by adding a reverse-thrust roller to Miranti's Mobius blade.

FIG. 8 is a side cross-sectional view of a possible embodiment of this invention being used to provide reverse thrust support to a common blade guide design for prior art single-edged blade.

### DETAILED DESCRIPTION OF THE INVENTION

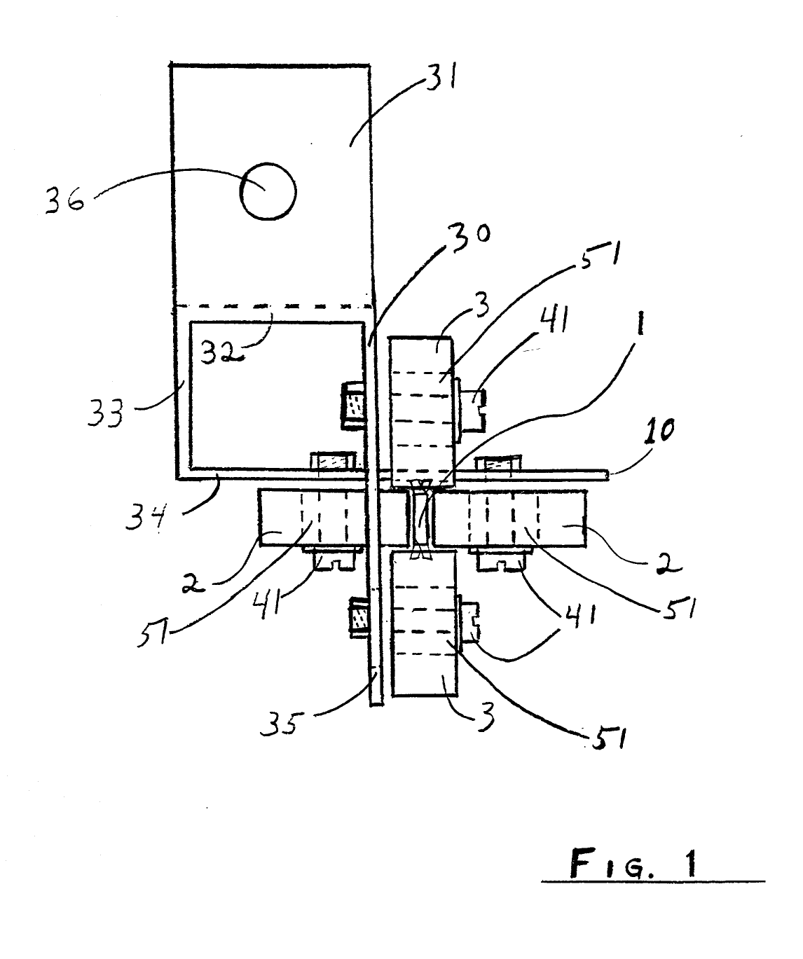

FIG. 1 shows a double-edged bandsaw blade 1 in cross-section as it would engage the blade guide assembly 10 in use, where pinch roller assemblies 2,2 support the blade 1 parallel to the cut plain to prevent sideways deflection and twisting while thrust roller assemblies 3,3 support the blade against deviation from fore-and aft deflection from its travel path through the blade transport wheels which are common to the art and therefore not described in detail here.

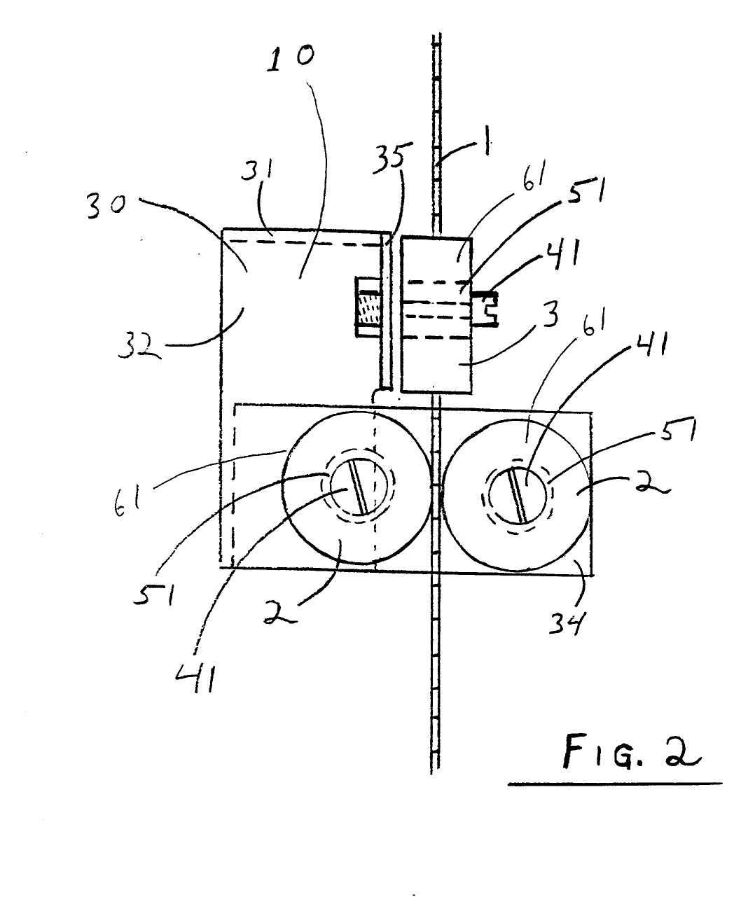

FIG. 2 shows a front plan view of the pinch roller assemblies 2,2 which are comprised of a cylindrical, elastomer wheel 61, a radial bearing 51, and a shaft 41.

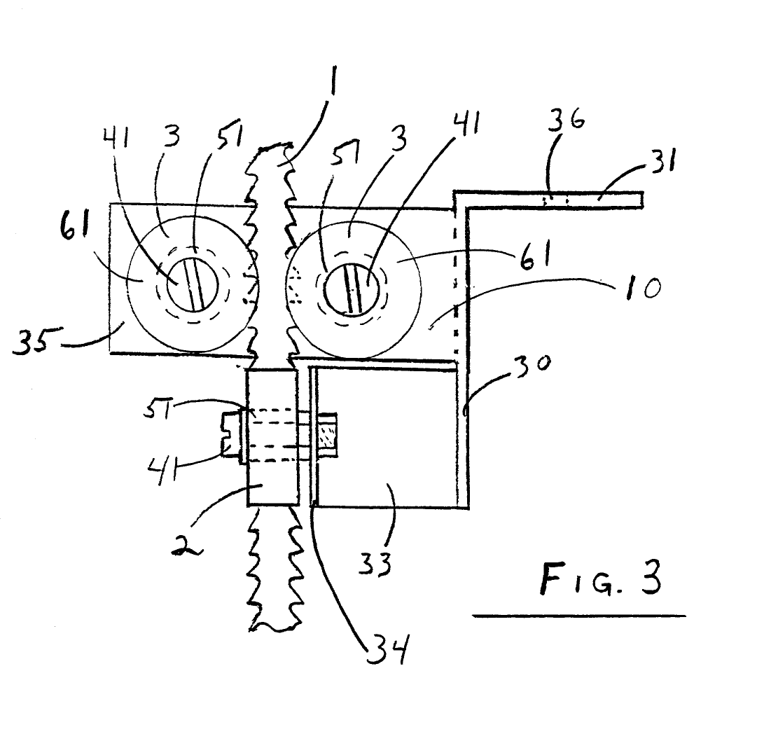

FIG. 3 shows a front view of the thrust roller assemblies 3,3 which are comprised of a cylindrical, elastomer wheel 61, a radial bearing 51, and a shaft 41. For reasons of economy, simplicity, and interchangeability the thrust rollers 3 and the pinch rollers 2 are identical in composition but are hereafter referred to in terms of their function.

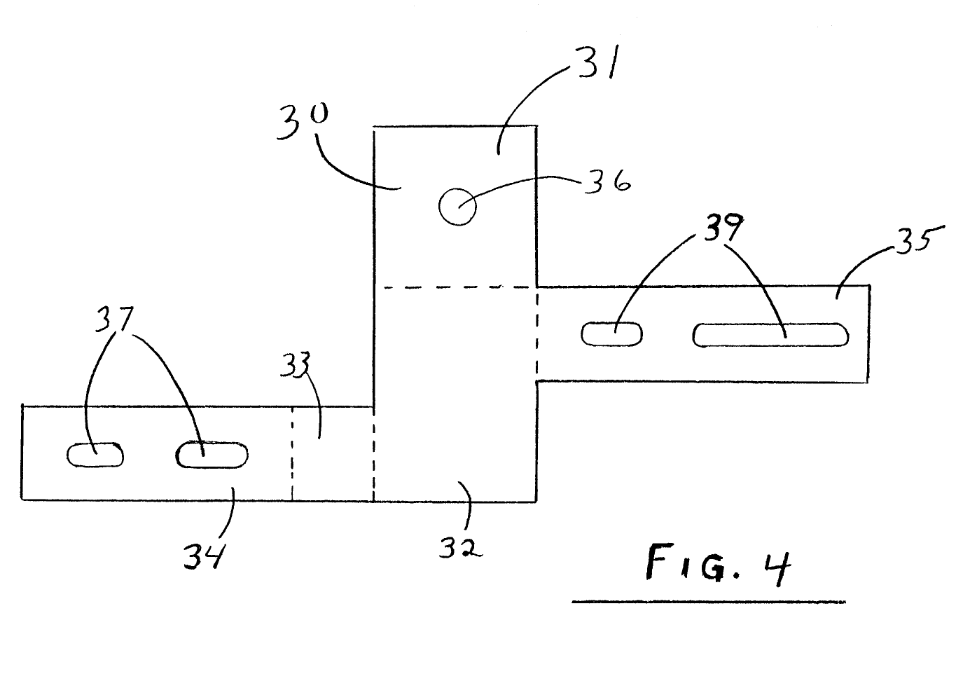

FIG. 4 shows a fold-out view of the blade guide bracket 30 in its preferred embodiment and corresponds to the blade guide assemblies 10 shown in FIGS. 1 through 3. Said blade guide bracket 30 serves to support pinch roller assemblies 2,2 and allow fine adjustments of same by means of elongated slots 37 in segment 34 of blade guide bracket 30. Likewise, blade guide bracket 30 supports the thrust roller assemblies 3,3 by means of elongated slots 39 in segment 35 of blade guide bracket 30. Segment 31 of blade guide bracket 30 serves as a flange to attach the blade guide assembly 10 to any bandsaw by means of bolt hole 36.

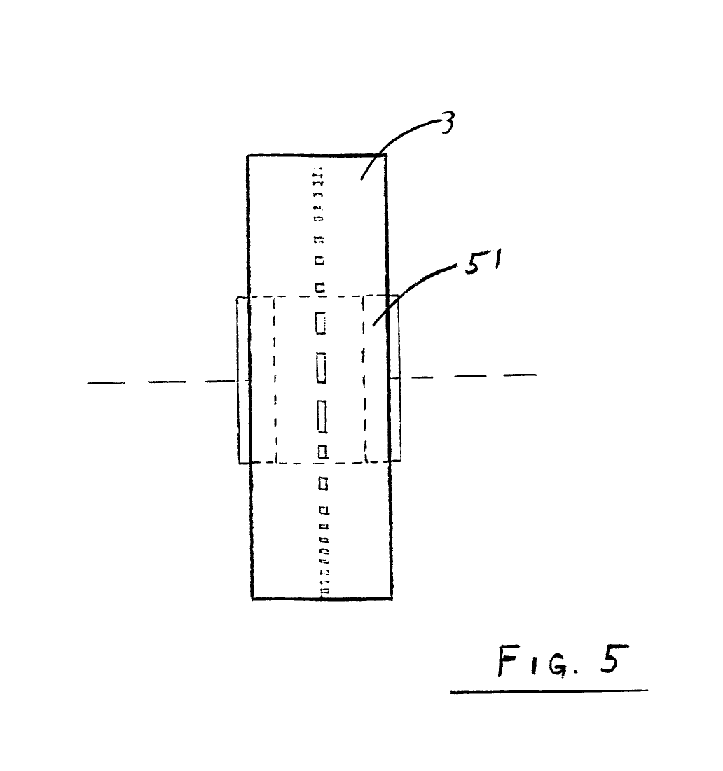

Thrust roller 3 shown in FIG. 5 shows the circumferentially arrayed indentations of the thrust rollers 3 outer surface in detail and highlights the resemblance of these rollers to an inverse manifestation of a sprocket.

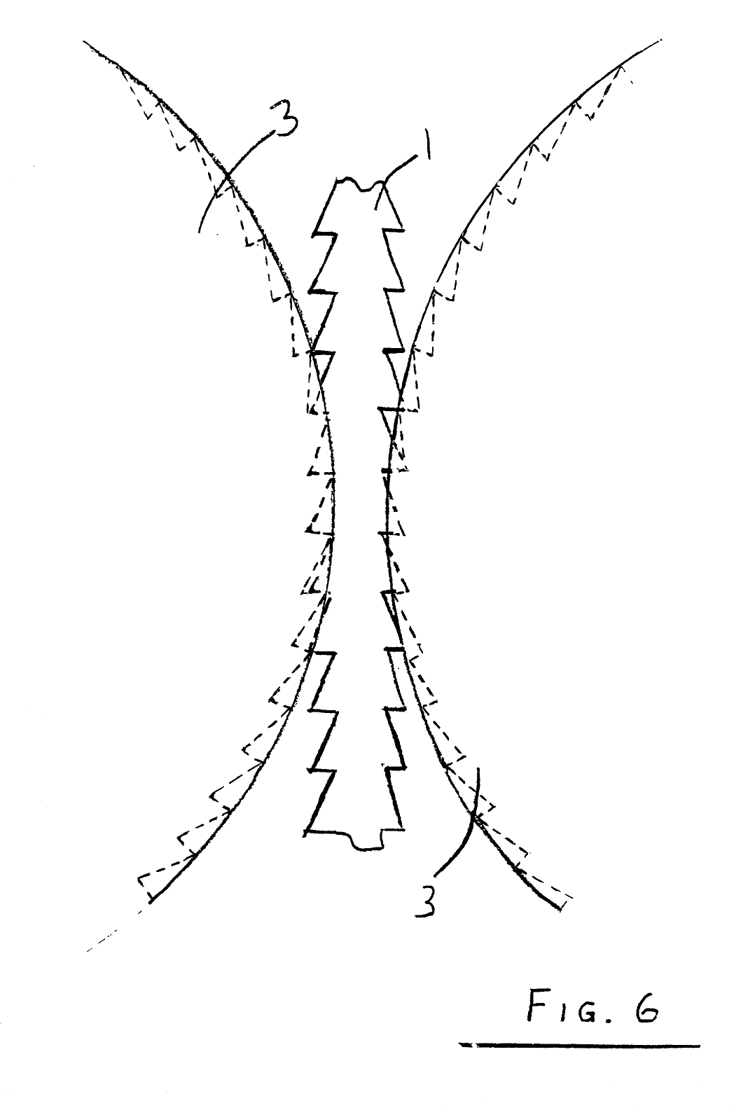

FIG. 6 shows a detailed cross-sectional front view of the blade's 1 synergetic relationship to the thrust rollers 3,3 of this invention. Since the indentations of the thrust rollers 3,3 are locked onto the teeth of the blade 1 and thrust force is distributed equilaterally along their interface, both attain a matching velocity, thus preventing friction or cutting of the rollers 3,3 or 2,2.

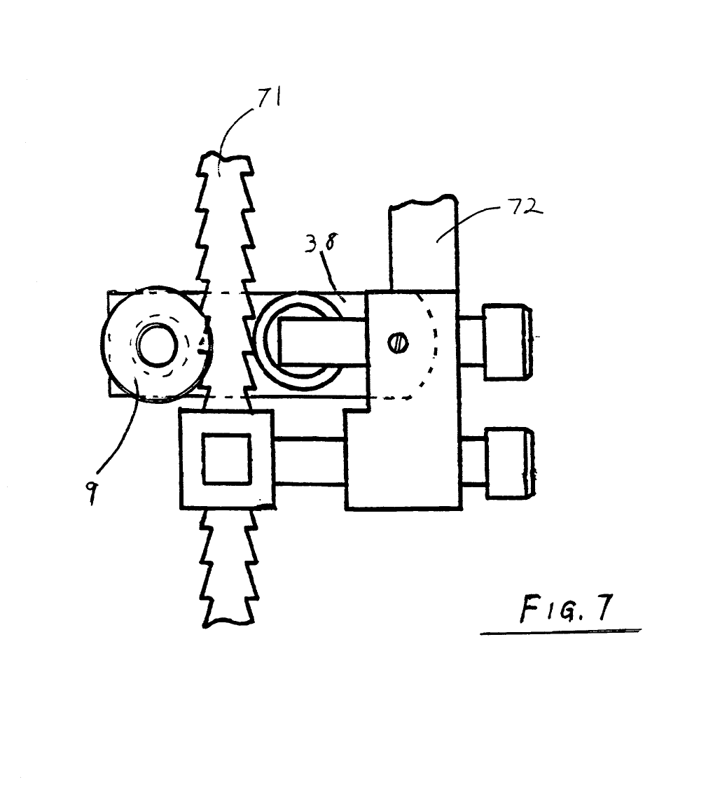

FIG. 7 shows a possible embodiment of this invention wherein reverse thrust roller assembly 9 provides opposing thrust support to the double-edged blade 71 of Mobius design through the prior art blade guides 72 of Miranti's U.S. Pat. No. 4,189,986 and supported by thrust roller support bracket 38.

It should be pointed out here that this invention differs substantially from Miranti's prior art in that: 1, from Miranti's drawings and specifications, the elastomeric “coating” or “tires” around his thrust support bearings lack the indentations and radial orientation necessary to prevent a toothed blade from beating itself and the bearing into immediate destruction and was obviously designed to work with a knife-edged blade only; 2, the blade guides of Miranti's prior art make no reference or provision for reverseable cutting with any kind of blade; and 3, repeated twisting through a Mobius configuration would significantly shorten the life of any blade's weldment.

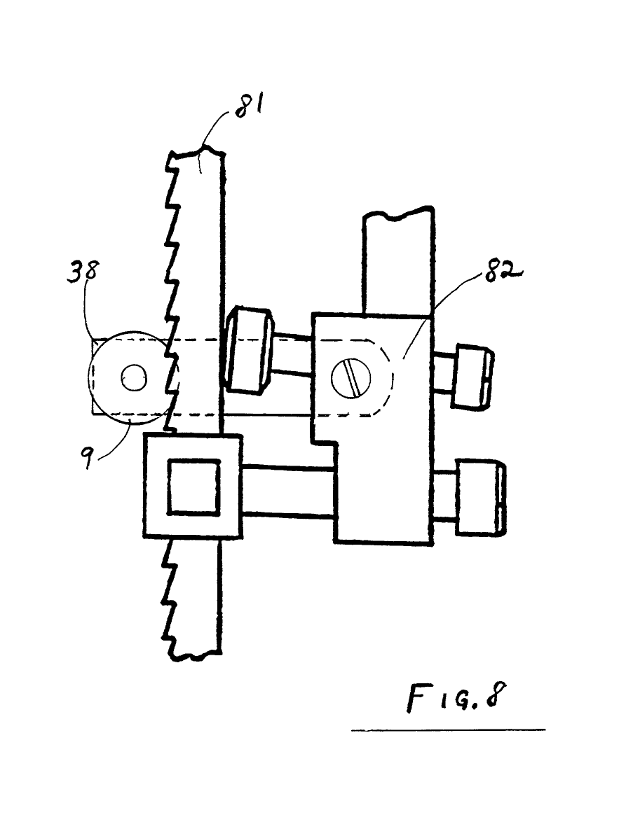

FIG. 8 shows the same embodiment of this invention as FIG. 7 only now it is providing reverse thrust support to a single-edged blade 81 in a blade guide 82 arrangement common to most bandsaws in use today.

The above disclosure sets forth a number of embodiments of the present invention. Other arrangements or embodiments, not precisely set forth, could be practiced under the teachings of the present invention and as set forth in the following claims.

I claim:

1. A double-edged bandsaw blade with means to support thrust in either direction of cut comprised of:
a bandsaw;
a double-edged bandsaw blade comprised of a metal band whose ends are joined to form a cylindrical loop with cutting teeth on both edges;
one or more of blade guide assemblies, each of which is comprised of a blade guide bracket assembly which supports two opposing pairs of elastomeric roller assemblies and a means to attach said blade guide assembly to a bandsaw.

2. The blade guide assemblies of claim 1 wherein the roller assemblies are comprised of a cylindrical wheel of elastomeric substance affixed to a radial bearing rotatably mounted on a shaft with means to attach said roller assembly to a supporting surface, such as said blade guide bracket assembly.

3. The blade guide assemblies of claim 2 wherein said roller assemblies are arranged around said blade in two pairs which are functionally designated as: pinch roller assemblies which serve to prevent sideways deflection and twisting of the blade by radially opposing each other on a plain perpendicular to the bladets cut plain and separated by the flat surface of said blade; while thrust roller assemblies serve to support thrust against the cutting edges by radially opposing each other parallel to the cut plain and separated by the cutting edges of said blade.

4. The thrust roller assemblies of claim 3 wherein said thrust rollers are comprised of elastomeric wheels whose circumferential thickness is greater than the distance between the gullets and the tips of the blade's teeth.

5. The thrust roller assemblies of claim 3 wherein said thrust rollers have indentations corresponding in size and shape to the teeth of said blade, such that as the blade travels along the rollers' circumference the rollers are driven synergetically, thus affording full support to thrust force against the blade while radially deflecting the lateral cutting force of the teeth.

6. The double-edged blade of claim 1 wherein said bandsaw blade's tooth length is consistently uniform and equals an integral factor of said thrust rollers' outside circumference.

7. The blade guide bracket assembly of claim 1 wherein said thrust roller assemblies and said pinch roller assemblies are supported in their positions relative to the blade by means of a metal plate with elongated adjustment slots formed in a shape that presents, relative to the cut plain; a perpendicular plain to support the pinch roller assemblies, a parallel plain to support the thrust roller assemblies, and a means to attach said blade guide bracket to a bandsaw.

8. A blade guide reverse thrust roller assembly comprising:
an elastomeric roller with indentations corresponding synergetically to the teeth of a conventional bandsaw blade in size and shape;
a radial bearing affixed internally to said roller;
a shaft upon which said radial bearing and elastomeric is mounted with means to attach said shaft to a supporting bracket;
a bracket to support said reverse thrust roller assembly in radial opposition to the cutting edge of a prior art bandsaw blade, with means to attach said bracket and reverse thrust roller to a bandsaw.
